(19) United States
(12) Patent Application Publication
(10) Pub. No.: US 2008/0102683 A1
(43) Pub. Date: May 1, 2008

(54) Electrical connector for attenuating vibrations, in particular for the injector of a motor vehicle engine

(75) Inventor: Frederic Menez, Hermeray (FR)

Correspondence Address: HARRINGTON & SMITH, PC, 4 RESEARCH DRIVE, SHELTON, CT, 06484-6212, US

(73) Assignee: FCI

(21) Appl. No.: 11/711,934

(22) Filed: Feb. 27, 2007

Related U.S. Application Data
(63) Continuation of application No. PCT/EP2005/009320, filed on Aug. 30, 2005.

(30) Foreign Application Priority Data
Aug. 30, 2004 (FR) 0409195

(51) Int. Cl. H01R 13/62

(52) U.S. Cl. 439/345

(57) ABSTRACT

The inventive connector includes a locking device for elastical interlocking which is provided with an axial stop surface forming jointly with the associate stop surface of the complementary locking device of a counterpart an mutual rest preventing the disconnection of the connector and the counterpart. Said connector includes an elastic vibration attenuating member arranged in such a way that it produces the mutual elastic rest force of the stop surfaces when the connector and the counterpart thereof are coupled. The invention can be used for connecting the injector of a motor vehicle internal combustion engine.

The present invention concerns an electrical connector designed to be coupled with a connector counterpart by elastic interlocking along a coupling direction, and comprising for this purpose a device that locks by elastic interlocking and has an axial stop surface provided in order to create, together with a stop surface associated with a complementary locking device of the counterpart, a mutual support opposing a disconnection of the connector and the counterpart.

In certain applications in severe environments, as is the case particularly for connection technology in the engine compartment of motor vehicles, the quality of the electrical contacts can be rapidly degraded and malfunctioning can be generated.

In the particular example of a connection device for an internal combustion engine injector, the connection base made in one piece with the engine is subjected to high levels of vibration and is also subjected to temperature levels that are also very high.

With connectors and bases of the known type, locking devices that offer a great simplicity of mounting of the connector onto the base, however, undergo significant wear and a loss of efficacy over the lifetime of the vehicle, due to these severe operating conditions. The progressive wear of the locking devices leads to an increase of the axial play between the connector and the base, so that friction is produced between the complementary contacts of the base and the connector.

Thus the functioning of known connection devices of the type disclosed above is affected in an amplified manner over time, since the appearance of play generates wear, which itself increases the play, etc.

The object of the invention is to resolve this problem without increasing the complexity of the locking devices of the connector and the base, and without increasing the difficulty of positioning the connector on the base.

For this purpose, the subject of the invention is an electrical connector of the above-mentioned type, characterized in that it comprises an elastic component for attenuating vibrations, arranged in such a way as to create an elastic force of mutual support for the stop surfaces, when the connector and its counterpart are coupled.

According to other characteristics of the invention:

the electrical connector comprises a peripheral seal, provided in order to assure tightness between the connector and its counterpart when they are coupled, and the elastic attenuating component makes up part of said seal;

the peripheral seal is a lip seal; and

the seal is made in one piece, particularly of an elastomer.

According to a first embodiment of the invention, the electrical connector comprises a casing on which is provided the locking device, and a contact-bearing module, which is mounted inside the casing by interlocking with the possibility of axial play, and the elastic attenuating component is arranged so as to be compressed axially between the module and the casing, when the module is mounted in the casing, with the effect of locking the connector onto the counterpart.

Preferably, the peripheral seal is mounted on said contact-bearing module.

According to a second embodiment of the invention, the connector comprises a contact-receiving casing, on which is provided the locking device, and the elastic component is provided so as to be compressed axially between the casing and the counterpart, with the effect of locking the connector onto the counterpart.

Preferably, the peripheral seal is mounted on said casing.

The invention also pertains to a device for electrical connection comprising an electrical connector such as defined above, and a base forming a counterpart for said connector, said base being a base of a motor vehicle part.

In particular, the base can be a base of an internal combustion engine part of a motor vehicle, particularly a base for the fuel injector.

Particular embodiments of the invention will now be described in more detail, in reference to the attached drawings, in which:

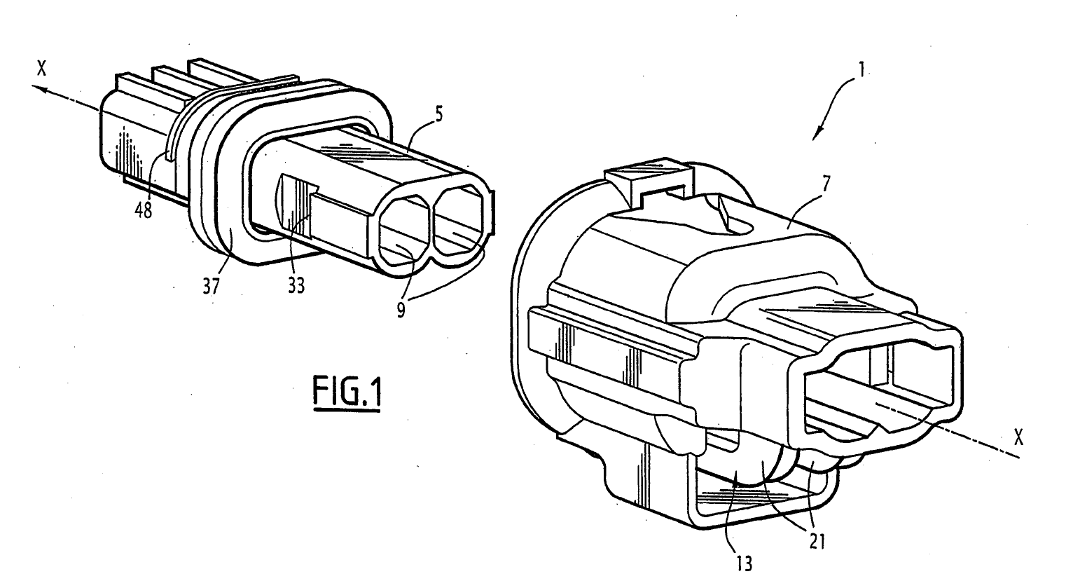

FIG. 1 is a partial perspective view of an electrical connector according to a first embodiment of the invention, the contact-bearing module being separated from the casing;

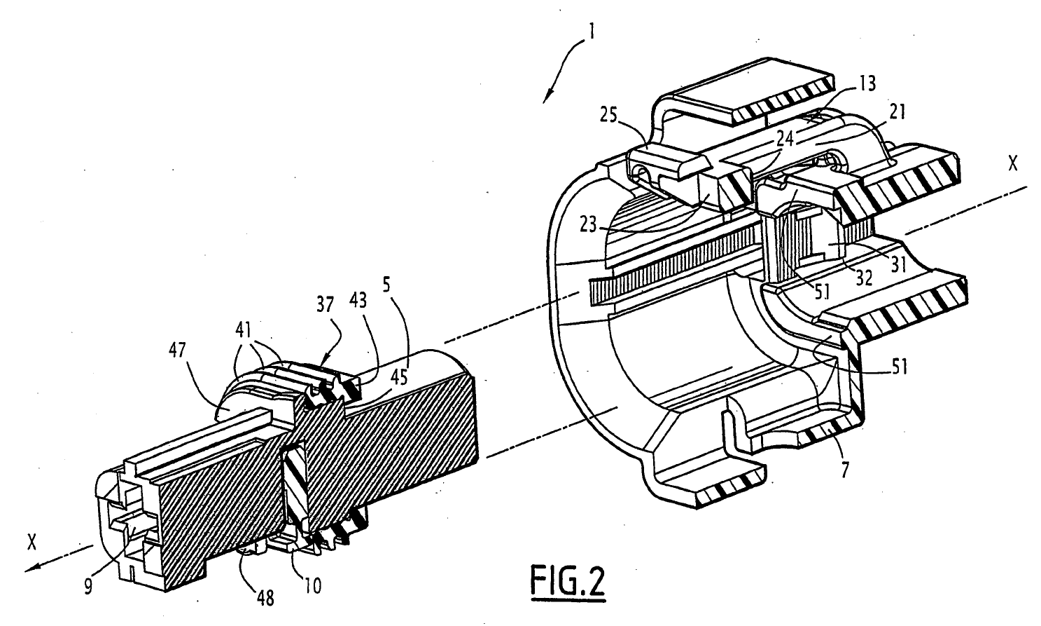

FIG. 2 is a view analogous to FIG. 1, cut in a median axial plane, and in a different direction from that of FIG. 1;

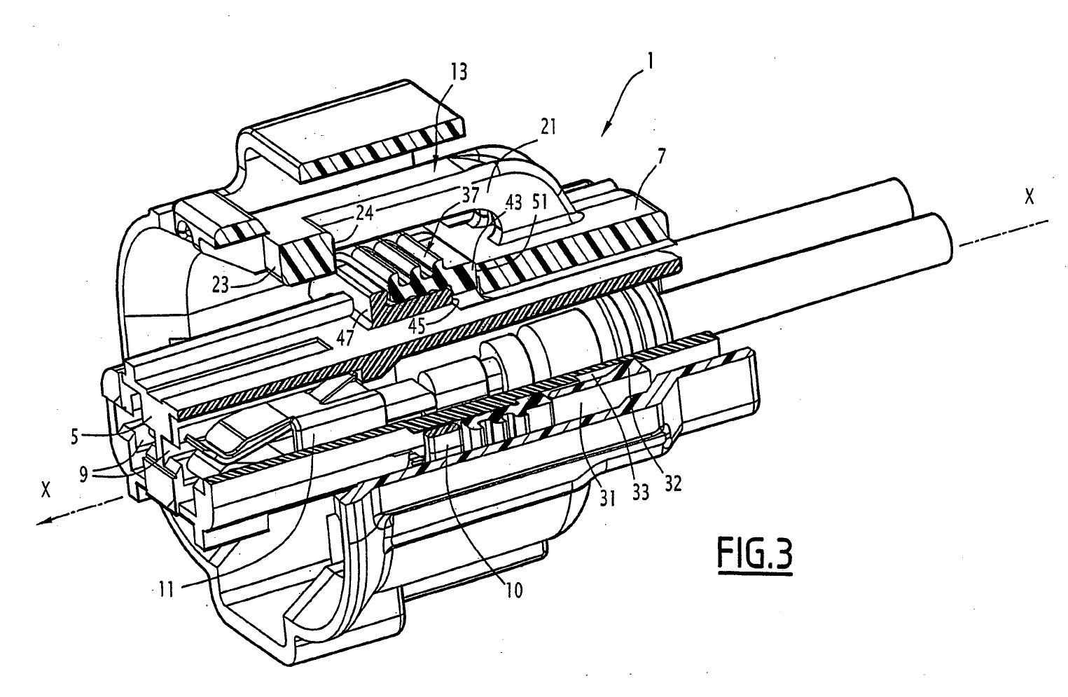

FIG. 3 is a perspective view of the connector of FIGS. 1 and 2, partially torn away, the module being mounted in the casing, and containing contacts connected to respective electric cables;

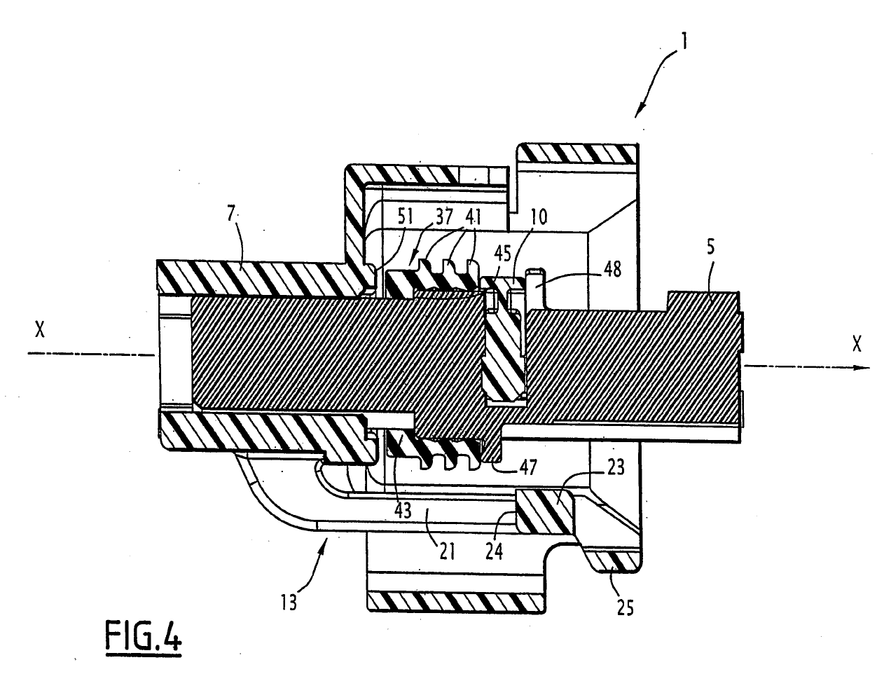

FIG. 4 is a sectional view, in a median axial plane, of the connector of FIG. 3;

FIG. 5 is a perspective view, cut in a median axial plane, of the connector of FIGS. 3 and 4, and of the base forming the counterpart, in a ready-to-engage position;

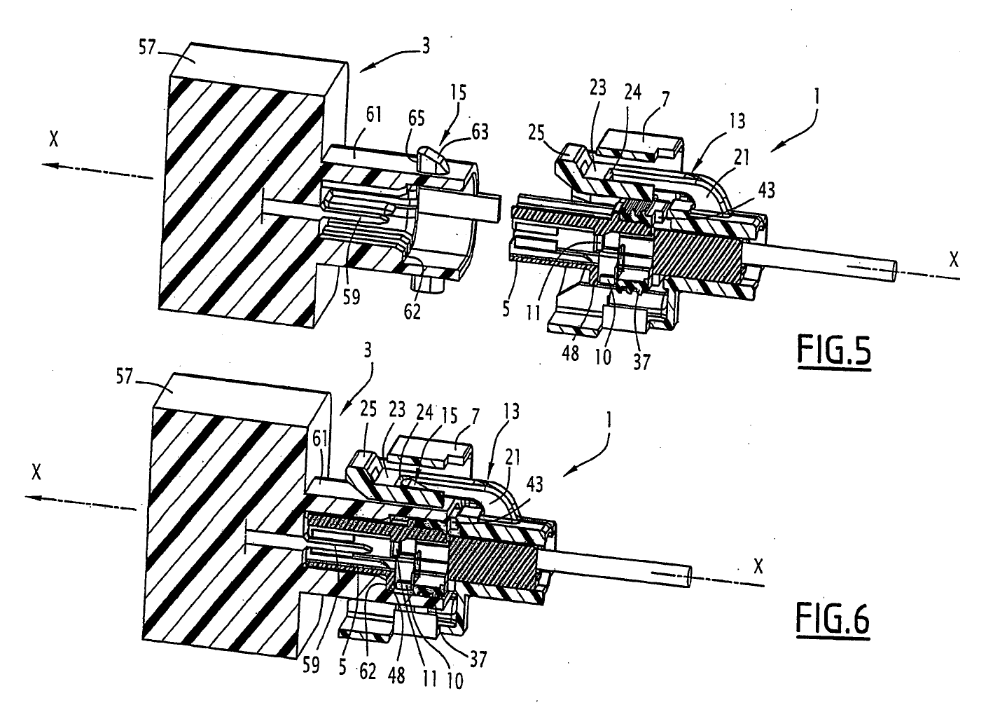

FIG. 6 is a view analogous to FIG. 5, in the position of complete engagement of the connector and the base;

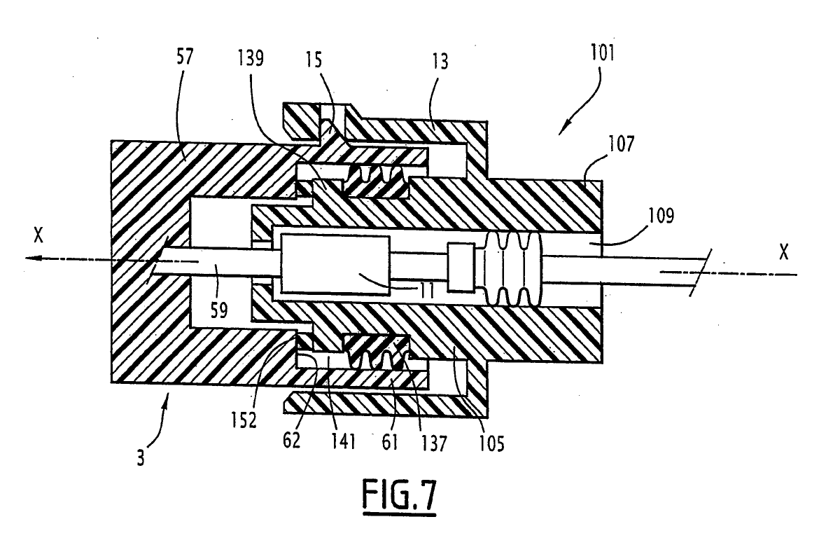

FIG. 7 is a schematic view, in section, in a median axial plane, of a connector according to a second embodiment of the invention and the base, in a position of mutual engagement.

In FIGS. 1 to 6, we have shown an electrical connector conforming to a first embodiment of the invention.

In the example shown, this connector 1 is of the two-way type for an injector of the internal combustion engine of a motor vehicle, provided to be coupled with a base 3 (FIGS. 5 and 6) forming a counterpart for the connector.

In all the Figures, we have introduced an X axis corresponding to the direction of coupling and oriented in the direction of engagement of the connector towards the base. The terms “front” and “back” used in the following will be understood with regard to this orientation, supposing that the connector is engaged onto the base by a movement from back to front.

The terms “axial” and “transverse” will also be understood with regard to this X axis.

In the first embodiment of the invention represented in FIGS. 1 to 6, connector 1 comprises a contact-bearing module 5 and a casing 7, both of insulating material.

Module 5 is formed with two axial sockets 9, in which respective contacts 11 are received and fastened (only shown in FIGS. 3, 5, and 6).

Module 5 comprises a secondary locking key 10, mounted in a transversely mobile manner relative to sockets 9, between a standby position in which it permits complete insertion of the contacts in the sockets, and a service position in which it locks the contacts thus engaged in the sockets, opposing a force that would pull them out. Secondary locking key 10 extends generally along a transverse plane, i.e., orthogonal relative to the X axis.

Casing 7 is designed as an envelope in which module 5 can be arranged and fixed, and has a locking device 13, provided to assure, together with a complementary device 15 of base 3, the detachable attachment of connector 1 onto base 3 in the coupled position.

Components 13, 15 for mutual locking of the connector and the base 3 are means for elastic interlocking functioning axially, i.e., along coupling direction X.

In the example shown, locking device 13 has two essentially parallel axial elastic arms 21, formed projecting and overhanging from a peripheral wall of casing 7. It also comprises a bridge 23 connecting the two axial arms 21 from the side of their free end situated in front and having a transverse stop surface 24 for the rear side. Locking device 13 also comprises a maneuvering button 25, formed at its free end.

On the inside, casing 7 has elastic interlocking components 31 (FIG. 2), in the form of lateral flexible tabs.

Each elastic tab 31 has a tooth 32 formed at its free back end, which is provided to be engaged in a corresponding notch 33 formed laterally on module 5 (FIG. 1). Tooth 32 and notch 33 define together, when module 5 is elastically interlocked in casing 7, an axial support opposing removal, from back to front, of module 5 relative to casing 7. It will be noted that interlocking components 31 and notches 33 are designed to allow a relative axial play from front to back of module 5 relative to casing 7, from the support position of the tooth against the shoulder formed by notch 33, as is shown in FIG. 3.

Moreover, connector 1 comprises a peripheral lip seal 37 mounted by fitting onto module 5, and provided to assure an interfacial tightness between base 3 and connector 1.

As is particularly visible in FIGS. 2 to 4, seal 37 has the general shape of a sleeve provided with a series of flanges 41 in radial projection defining lips (three in the example shown), and has, on the front side, a rim 43 forming a shoulder.

In a corresponding manner, module 5 has a first peripheral back rim 45 forming a shoulder for rim 43 and, over a part of its periphery, successively from back to front from the first rim, a second rim 47 and a third rim 48.

When module 5 is in its interlocked position in casing 7 (see FIG. 4, in particular), rim 43 of the seal is supported on peripheral rim 45 of module 5.

Seal 37 is then positioned without contact relative to a bottom surface 51 of casing 7, which is inscribed in an annular surface, and situated in the axial extension of the seal.

It will be noted that the secondary locking key 10 is arranged at the front of the support surface of rim 47, provided to receive and support seal 37. Thus, the seal does not come into contact with said key 10, and it does not hinder the movement of this key.

By referring to FIGS. 5 and 6, we will now succinctly describe base 3, which was shown schematically in these Figures.

Base 3 comprises an insulating casing 57 in which a series of contacts 59 are arranged, terminal pins here, complementary to contacts 11 seated in module 5. Casing 57 is formed with a skirt 61 inside of which terminals 59 project axially.

The inside of skirt 61 is formed with a peripheral shoulder 62, which constitutes an engagement stop for rim 48 of module 5.

Locking device 15 complementary to locking device 13 of casing 7, is formed radially projecting from skirt 61. It is present as a tooth piece endowed with an inclined ramp 63 turned toward the back, and with a back surface 65 which is transverse relative to the X coupling axis, this stop surface 65 facing the front.

As is visible more particularly in FIG. 6, when connector 1 and base 3 are in mutual coupling position, the interfacial tightness between module 5 and casing 57 is created by contacting lips 41 with the inner surface of skirt 61.

By referring again to FIGS. 5 and 6, one understands that the locking of connector 1 onto base 3 during their mutual coupling is produced in the manner explained below, module 5 being fixed inside casing 7 beforehand, as shown in FIGS. 3 and 4.

When module 5 is axially engaged in skirt 61, bridge 23 of locking device 13 comes to be supported on inclined ramp 63 of tooth piece 15.

When this movement of axial engagement is continued, arms 21 are deformed by bending and move away from the X axis, bridge 23 following inclined face 63, until tooth piece 15 is engaged between arms 21 due to their elastic recoil to their rest position.

Stop surface 24 of bridge 23 then comes to be supported on stop surface 65 of tooth piece 15, so as to oppose the removal of connector 1.

During this phase of engagement, before elastic recoil of arms 21, front rim 48 of module 5 comes to be stopped on inner shoulder 62 of skirt 61, so that the rest of the engagement movement of connector 1 onto base 3 is accompanied by a relative axial movement of casing 7 relative to module 5. This relative movement is permitted by the axial play of tooth 32 in notch 33. Thus, surface 51 of the bottom of casing 7 comes into contact with the rear face of seal 37, by compressing rim 43 between this annular face 51 and peripheral rim 45 of the module.

When arms 21 elastically return to their rest position, at the end of the engagement phase, rim 43 of seal 37 elastically pulls stop surfaces 24, 65 of locking devices 13, 15 into mutual support, rim 43 of the seal remaining compressed.

When connector 1 and base 3 are thus coupled and in service position, rim 43 of the seal makes use of the elastic vibration attenuating component which limits the relative movements of stop surfaces 24, 65 of the locking devices.

Thus, as long as the acceleration forces caused by vibrations remain inferior to the support forces between stop surfaces 24, 65 and surfaces 48, 62, there is no longer any relative movement inducing wear of the parts, and in the case where they may exceed the support forces, said movements are of lesser amplitude.

It will also be noted that rim 43 is undercut over a part of the seal periphery (see FIGS. 5 and 6) so that the axial compression of seal 37, during coupling, is created solely over a part of the periphery of the seal. This characteristic permits adjusting the elastic recoil force applied to the locking devices, and so that the coupling of connector 1 onto base 3 does not require an excessive coupling force.

The one-piece (or single block) design of the seal and the elastic component has the advantage of low cost of manufacture and mounting.

However, the invention can also be envisioned, as will be seen in the following, with an elastic component separate from the seal. In such a case, one can possibly choose different materials to create the elastic component, on the one hand, and the seal, on the other hand. For example, an elastomer having specific attenuating properties can be chosen to make up the elastic component. As a variant, this elastic component could be made up of a metal spring.

In FIG. 7, a connection device conforming to a second embodiment of the invention is shown schematically, in which base 3 is identical to the base shown in FIGS. 5 and 6. In this embodiment, complementary connector 101 differs from connector 1 essentially in that it does not have a contact-bearing module, and in that the elastic component is a separate piece from the seal, as mentioned above.

Sockets 109 for receiving contacts 11 are formed in insulating casing 107. This casing is provided with a locking device 13, which can be identical to that described previously and shown in FIGS. 1 to 6.

Casing 107 thus comprises a body 105 analogous to module 5, and on the peripheral surface of which is fitted lip seal 137. A shoulder 139, formed projecting radially from the outer surface of body 105, receives seal 137 in axial support, so as to hold the seal in its functioning position on body 105.

The connector also comprises an annular elastic component 152, arranged on a periphery of casing 107, in the axial extension of the seal, and supported on the opposite side of shoulder 139. In the example shown, elastic component 152 is made of the same elastomer material as lip seal 137.

Elastic component 152 is analogous to rim 43 in the first embodiment described, in that it constitutes the elastic attenuating component, which is compressed during the coupling of connector 101 onto base 3, and which elastically pulls the stop surfaces of complementary locking devices 13, 15 into mutual support at the end of the engagement phase.

As is visible in FIG. 7, elastic component 152 is compressed between inner shoulder 62 of the base and shoulder 139.

By minor modifications of existing connectors, and, in particular, by minor modifications of peripheral lip seals, the invention that has just been described permits reducing the effects of vibration on the wear of the locking devices, and incidentally, improving the contact reliability of the connection device.

The advantage obtained is particularly important in the case of connectors for fuel injection systems for motor vehicle engines, given the high level of vibrations, temperature and mechanical stresses.

1. An electrical connector provided to be coupled with a connector counterpart by elastic interlocking along a coupling direction (X), and comprising for this purpose a device that locks by elastic interlocking and has an axial stop surface provided to create a mutual support, together with an associated stop surface of a complementary locking device of the counterpart, opposing a disconnection of connector and counterpart, said connector also comprising an elastic component arranged in such a way as to create an elastic force of mutual support of stop surfaces, when connector and its counterpart are coupled, characterized in that it comprises a casing on which is provided locking device and a contact-bearing module, which is mounted inside casing by interlocking with possibility of axial play, and in that this elastic attenuating component is arranged so as to be compressed axially between module and casing, when module is mounted in casing, with the effect of locking connector onto counterpart.

2. The electrical connector according to claim 1, further characterized in that it comprises a peripheral seal provided so as to assure tightness between connector and its counterpart when they are coupled, and in that elastic component is part of said seal.

3. The electrical connector according to claim 2, further characterized in that peripheral seal is a lip seal.

4. The electrical connector according to claim 2, further characterized in that seal is made in a single piece, particularly of an elastomer.

5. The electrical connector according to claim 1, further characterized in that peripheral seal is mounted on said contact-bearing module.

6. An electrical connection device comprising an electrical connector according to claim 1, and a base forming a counterpart of said connector, said base being a base of a motor vehicle part.

7. The electrical connection device according to claim 6, further characterized in that said base is a base of an internal combustion engine part of a motor vehicle, in particular, a base of the fuel injector.
